(19) United States
(12) Patent Application Publication
(10) Pub. No.: US 2019/0257292 A1
(43) Pub. Date: Aug. 22, 2019

(54) METHOD FOR HANDLING A WIND TURBINE BLADE

(71) Applicant: SOLETANCHE FREYSSINET, Rueil Malmaison (FR)

(72) Inventors: Benoit MELEN, Bois Colombes (FR); Nicolas FABRY, Antony (FR); Eric LAURENT, Boissy-Sous-Saint-Yon (FR)

(21) Appl. No.: 16/310,153

(22) PCT Filed: Dec. 9, 2016
(86) PCT No.: PCT/FR2016/053319

§ 371 Date: Dec. 14, 2018

(30) Foreign Application Priority Data
Jun. 16, 2016 (FR) 16 55613

(51) Int. Cl. F03D 13/10

(52) U.S. Cl. CPC F03D 13/10; F05B 2230/61

(57) ABSTRACT

In order to handle a wind turbine blade between the ground and a rotor of an electric generator mounted on a nacelle (15) at the top of a tower (10), the blade (25) is retained in a support (40) that is mounted on a trolley (30) arranged against the tower. The trolley is moved and guided along the tower using at least one cable (32, 33) which is angled in such a way as to apply a force having a horizontal component in the direction of the tower to the trolley.

The present invention relates to the mounting of wind turbine blades, as well as the removal thereof.

### BACKGROUND

To install or uninstall wind turbine blades, most often heavy duty cranes are used that are capable of lifting heavy loads to the height of the tower, for example the same cranes used to equip the nacelle. Use of such cranes for assembling wind turbines is problematic since renting them is quite costly and weather conditions allowing manipulation of the blades are not guaranteed.

Whereas wind turbine blades are bulky, with a length of more than 50 meters for large wind turbines, they are not so heavy, for example from 10 to 15 tons. Using large cranes is therefore not necessary, even though it is currently the most often used means.

As an alternative, U.S. Pat. No. 7,785,073 proposed mounting or removing a wind turbine blade using at least one cable extending between the ground and a part mounted to the nacelle, for example the rotor hub of the generator, and moving the blade along that cable. However, the blade is still sensitive to winds or other effects as it proceeds along the cable, even though this is normally carried out under favourable weather conditions. In the event of unexpected wind, safety requires the nacelle to be reoriented before working on the second or the third blade, but the cable system complicates the operation. Furthermore, this solution does not allow for the blade to be docked on to the hub, which is still a delicate procedure.

An object of the present invention is to propose a more practical technique for raising and lowering wind turbine blades without using tall cranes.

### SUMMARY

A method is proposed for handling a wind turbine blade between the ground and an electric generator rotor installed on a nacelle at the top of a tower. The method comprises: holding the blade in a blade holder mounted on a cart placed against the tower; and moving and guiding the cart along the tower, using at least one cable inclined so as to exert a force on the cart having a horizontal component in a direction towards the tower.

The cart bearing the blade bears on the tower during lifting (or lowering) to (or from) the high position where the blade can be connected to (or disconnected from) the rotor.

Such bearing, which stabilizes the blade during movement, is secured by the force having a horizontal component exerted on the cart by at least one cable that (i) provides force for lifting the cart or curbing the descent thereof, and/or (ii) assures the guidance thereof during the movement along the tower.

Once the high position is reached, the cart is still kept firmly against the tower by the cable(s), which makes it easier to connect the blade to the rotor of the generator. It is possible to pivot the nacelle and/or turn the rotor and/or adjust the height of the cart and/or move the blade holder with respect to the cart to present the blade connection interface in good conditions to ensure assembly.

Wind turbine rotor blade installing and removal operations, which are made much simpler, do not necessarily require tall cranes. The time and cost of the operation are thus minimized.

In one embodiment, the cart is guided along the tower independently of the nacelle which is mounted high enough at the top of the tower to be able to pivot about the vertical axis.

To ensure guidance of the cart, several types of systems can be used. One possibility is to install a guide system between the cart and the tower, comprising at least one vertical rail and shoes engaging with the rail to guide the cart when moving along the tower.

In addition to the function of laterally guiding the cart and the blade to keep them on their vertical path, this guide system can also help to keep the cart against the tower by appropriate engagement of the shoes with the rail.

According to one option, the rail belongs to the cart and the shoes are mounted on the tower. The shoes can, in particular, be installed through windows provided in the wall of the tower during its construction. Another option is for the rail to be mounted to the tower and for the shoes to be situated at a lower part of the cart.

An alternative form of the guide system comprises two cables arranged symmetrically on either side of a vertical plane. Each of the guide cables can be connected to a point situated at the foot of the tower and at a point situated at an upper part of the tower and be deviated by an angular return element provided on the cart. The points of connection of the two guide cables are advantageously provided in such a way that the guide cables exert a force with a horizontal component on the angular return elements of the cart in the direction of the tower. The points of connection of the two guide cables on the upper part of the tower may be arranged under the nacelle. Adjusting the tension is optionally used to further ensure the guide function of the cart.

In one embodiment, at least one traction cable is connected to the cart to drive the cart as it is raised along the tower, or for holding back the cart as it is lowered along the tower, the traction cable being inclined so that the traction it exerts on the cart has a horizontal component in a direction towards the tower. The cart may comprise at least one return pulley to perform reeving of the traction, thus making it possible to limit the traction force required to move the cart and the blade. The traction cable can be deviated by at least one pulley situated in the upper part of the tower and connected to a winch or a brake situated at the foot of the tower.

In one embodiment, the blade support is pivotally mounted on the cart, about a substantially horizontal axis. To orient the blade naturally during movement, the support should hold the blade in a region situated between its proximal end, i.e. the end to be connected to the electric generator rotor, and its centre of gravity. To facilitate the manoeuvre, it is preferable for the region where the blade holder holds the blade to be closer to the centre of gravity than to its proximal end.

In one embodiment of the method, the blade is brought to the foot of the tower in a horizontal position where it is gripped in the blade holder mounted on the cart. The cart is then moved upwardly by supporting a distal portion of the blade until the cart has reached a height where the blade extends vertically with its distal end downward, and then the upward displacement of the cart is continued until the proximal end of the blade reaches the electric generator rotor.

The blade holder may comprise a clamp having a lining shaped to adapt to the outer profile of the blade.

To connect the blade to the electric generator rotor, the latter is positioned to have a hub location facing the proximal end of the blade. In one embodiment of the method, when the cart arrives at the top of its path along the tower, it is controlled so as to adjust the position of the proximal end of the blade with respect to the hub location. Advantageously, the cart is arranged to adjust the position of the proximal end of the blade according to at least one degree of freedom among: translation in a radial direction relative to the tower, rotation about a horizontal axis perpendicular to a radial plane relative to the tower, rotation about a longitudinal axis of the blade.

To increase safety during manoeuvring of the blade, it is possible to add to the cart a system for locking it relative to the tower, activatable by an operator. This locking system comprises for example a strap or the like, connected to the cart and forming a loop around the tower, the cart being equipped with an actuator for tensioning the strap in response to an operator input.

### BRIEF DESCRIPTION OF THE DRAWINGS

Other features and advantages of the present invention will appear in the following description of a nonlimiting example of an embodiment, with reference to the accompanying drawings, in which:

FIG. 1 is a schematic side view of a wind turbine with a blade that is moving along the tower in the direction I-I shown in FIG. 2;

FIG. 2 is a front view diagram of the wind turbine, in the direction II-II shown in FIG. 1;

FIG. 3A is a sectional diagram along a horizontal plane (A-A in FIG. 3B) of a cart holding a blade to accompany its movement along the tower of a wind turbine;

FIG. 3B is a sectional diagram of the same cart, according to a radial plane (B-B in FIG. 3A);

FIG. 3C shows a detail of the cart, in the direction C indicated in FIG. 3A;

FIGS. 4A-C are simplified diagrams of a wind turbine, illustrating an example of an operation of loading the blade on to the cart and the beginning of its ascent along the tower;

FIG. 5 is a diagram showing another embodiment of a cart for raising or lowering a wind turbine blade along a tower; and

FIG. 6 is a diagram of a detail of FIG. 5, seen in cross section along the horizontal plane VI-VI.

### DESCRIPTION OF EMBODIMENTS

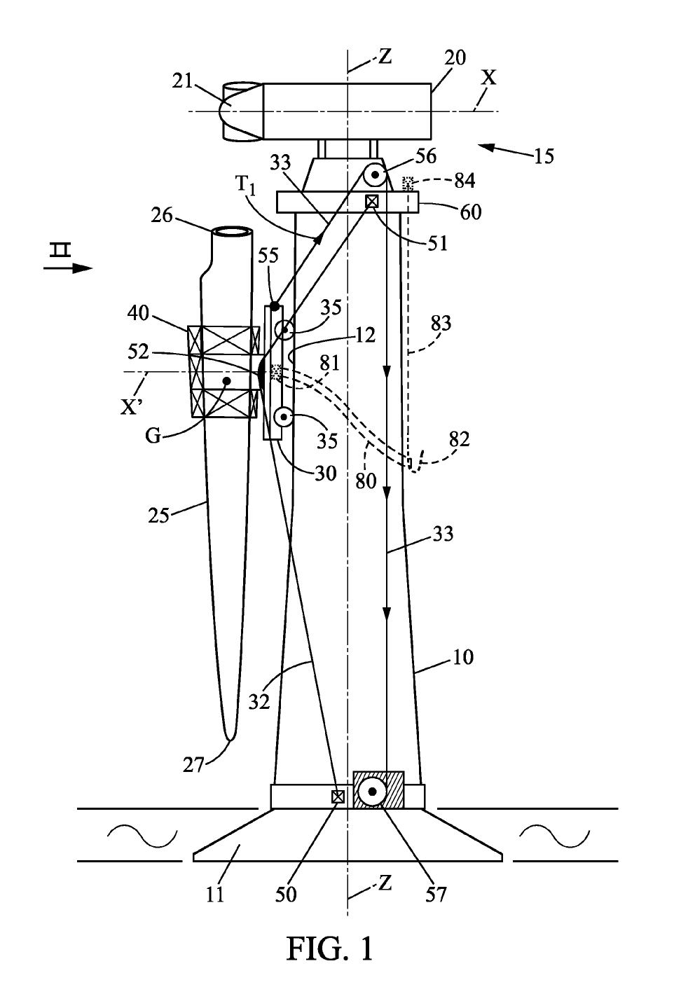

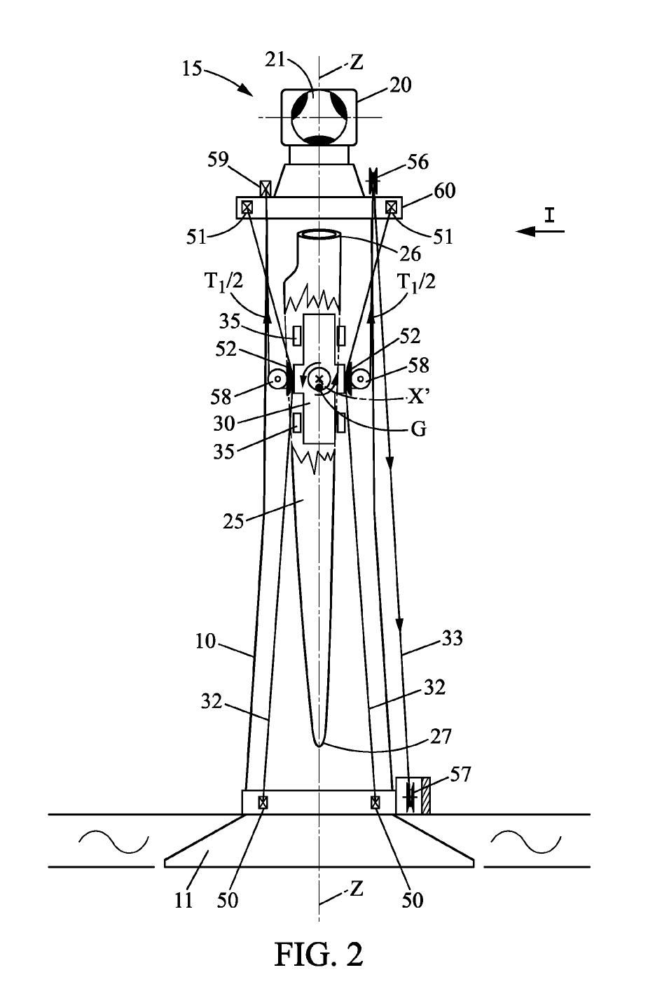

FIGS. 1 and 2 show schematically a wind turbine having a tower 10 topped with a nacelle 15. To facilitate reading of these two figures, the horizontal dimensions of the wind turbine tower are exaggerated in relation to its vertical dimension. In practice, the vertical dimension of the tower, for example approximately 150 m, is more than 10 times greater than its horizontal dimensions.

The tower 10 stands on a foundation 11 built in the ground. Typically, the tower 10 is made by assembling prefabricated concrete elements, over all or part of its height. The concrete elements are prestressed by vertical cables (not shown) to ensure the tower 10 has good resistance to the bending forces that the wind will exert on it.

The top of the tower 10 is equipped to accommodate the nacelle 15 which has a mount for pivoting about the vertical axis Z of the tower. The nacelle 15 is intended to receive the electric generator 20 of the wind turbine, the rotor of which has a hub 21 for receiving three blades 25 oriented at 120° with respect to the axis X of the rotor. Only one blade is shown in the drawings. Each blade 25 at a proximal end 26, having a connection interface with the hub 21 of the rotor, and a distal end 27.

To handle the blade between the ground and its docking position on the hub 21, the method implements a cart 30 which moves along the tower 10 and a traction and guide system using one or more cables. In the examples shown in FIGS. 1 and 2, this system comprises a traction cable 33 and two guide cables 32.

The cart 30 moves on the wall 12 of the tower 10 in a vertical plane P parallel to the view of FIG. 1. The vertical plane P is radial, that is to say, it contains the axis Z of the tower 10. The cart 30 has a frame provided with wheels 35 which are four in the example shown to allow the cart to roll in its path along the tower 10. The wheelbase of the wheels 35 is typically a few meters, for example 5 to 6 m.

A blade support member 40 adapted to hold the blade 25 during its movement is mounted on the frame of the cart 30. The blade support member 40 has a degree of freedom in rotation relative to the cart 30, about a horizontal axis X′ substantially perpendicular to the plane in which the cart 30 rolls defined by its wheels 35.

The wheels 35 provide a certain guidance to the cart 30 in its vertical path along the tower 10. However, in the example shown, the guiding function is also provided by the cables 32 which have a symmetrical arrangement around the radial plane P.

The guidance of the cart 10 is operated independently of the nacelle 15, by elements located under the nacelle.

In the example considered, each of the guide cables 32 has a first anchoring point 50 at the lower part of the tower 10, near the foundation 11, and a second anchoring point 51 at the top of the tower 10, near the nacelle 15 but beneath it (so that the nacelle can rotate without hindrance around its axis Z). The cart 30 comprises an angular return element 52, such as a saddle or a pulley, for each of the guide cables 32. The angular return elements 52 are mounted on both sides of the cart 30 so that each of them engages with one of the guide cables 32. Each cable 32 therefore extends between its two anchoring points 50, 51 forming a bend at the angular return element 52. The altitude of the elbow changes at the as the cart 30 moves along the tower 10.

If the elasticity of the guide cables 32 is not sufficient to allow slight variation in their length when the cart 30 moves, it is possible to provide the guide cables with a tensioning mechanism 32. This tensioning mechanism (not shown) comprises for example a jack that stretches each of the cables 32 by absorbing the variation in length due to the movement of the angular return element 52. The jack is for example located in the lower part of the tower. It may be common to the two guide cables 32. Alternatively, there is a jack for each cable 32. The voltage adjustment may be useful for balancing the forces exerted by the two guide cables 32 on the cart 30 so that the guidance is more efficient.

As shown in FIG. 1, the positioning of the low and high anchoring points 50, 51 of a guide cable 32 is such that the wall 12 of the tower 10 on which the cart 30 rolls is located between the angular return element 52 and the anchoring points 50, 51. As a result, the tension of the guide cables 32 results in a force exerted on the angular return element 52 and the cart 30 which has a horizontal component in a direction toward the tower 10. Said horizontal component of the force contributes to keeping the cart 30 against the wall 12 of the tower 10.

On the other hand, the symmetrical arrangement of the guide cables 32 and the angular return elements 52 on either side of the radial plane P (FIG. 2) ensures that the cart 30 remains well on its predefined vertical path.

The traction cable 33 is used to hoist the cart 30 when mounting the blade 25 on the hub 21, or to curb the descent of the cart 30 when removing the blade 25.

In the example shown in FIG. 1, the traction cable 33 extends between an attachment point 55 on the cart 30, a return pulley 56 situated in the upper part of the tower 10 and a winch 57 located at the base of the tower 10. Alternatively, it is possible to mount the winch 57 at the top of the tower. When lowering a blade 25, the winch 57 is replaced by a brake, unless the winch 57 has a braking function.

Between the point of attachment 55 and the top of the tower (pulley 56), the traction cable 33 follows an inclined trajectory, so that the traction T₁ which it exerts on the cart 30 has a horizontal component for holding the cart 30 against the tower 10.

In FIG. 1, the attachment point 55 is shown in front of the cart 30, so that the drawing is easier to read. In practice, the attachment point 55 may be located between the axles of the wheels 35 so that the cart 30 is better held against the wall 12 of the tower 10.

In addition, as shown in FIG. 2, the connection of the traction cable 33 to the cart 30 does not necessarily consist of an attachment point. In the example shown in FIG. 2, the cable 33 has a reeving arrangement at the level of the cart 30, which makes it possible to reduce the force coming from the winch 57. In the example, the cart 30 is equipped with two return pulleys 58 located on both sides, and the traction cable 33 passes under these two pulleys 58 to be returned to an anchor point 59 located at the top of the tower 10. Due to this arrangement, each pulley 58 receives from the traction cable 33 a force T₁/2 coming from the winch 57, which results in a total force T₁ on the cart. This force T1 has a vertical component that raises the cart (or curbs its descent) and a horizontal component that keeps the cart against the wall 12 of the tower 10.

The guide and traction system may comprise a platform 60 for the positioning of the anchoring points 51, the pulley 56 and/or the anchor point 59 at the top of the tower 10. The platform consists for example of a pair of beams fixed to the tower 10 at its upper part, under the nacelle 15. The concrete elements forming the tower 10 may, in the upper part thereof, be prefabricated so as to incorporate the beams of the platform 60 or have an interface for easy mounting and removal of the platform. The platform 60 is pre-equipped so that the positions of the anchor points 51, 59 and the pulley 56 are well defined so as to provide the guidance and pulling forces as described above.

The platform 60, as well as the cables 32, 33, the cart 30 and the winch 57, constitute an apparatus that can be moved from one wind turbine to another when blades 25 need to be mounted or removed.

It is possible to leave in place all or part of the equipment of the platform 60 to facilitate any maintenance operations during the life of the wind turbine. If the blades 25 are installed shortly after the installation of the nacelle 15 at the top of the tower 10, it is possible to use a platform which has been put in place for the installation of the nacelle 15 or the erection of the tower 10 as the platform 60 to hoist the blades 25. In the case where the work schedule is not compatible with this sequence, because there is too much time between the time when the tower 10 and the nacelle 15 are mounted and the moment when the blades 25 are installed, the upper platform 60 can be put in place for the purposes of handling the blades 25, using the winch the nacelle 15 is generally provided with for subsequent maintenance operations on the wind turbine.

The cables 32, 33 for guidance and traction of the cart 30 must remain relatively close to the wall of the tower 10 so as not to hinder the rotation of a rotor that has all or some of its blades 25.

FIG. 1 illustrates, in dashed lines, an option that can be added to the cart 30 to improve safety during handling of the blade 25. According to this option, a system 80-84 for locking the cart 30 relative to the tower 10 is provided to be put into service selectively by the operator, especially in the event of worsening weather conditions while the blade is being transported by the cart 30.

For example, the locking system comprises one or more straps 80 arranged in a loop around the tower 10, with both ends attached to the cart 30. The strap 80 is put in place, without being stretched, before that the cart 30 begins its vertical movement along the tower 10, then it moves along with the cart along the tower. To ensure that the strap 80 accompanies the vertical movement of the cart 30 without hindering it, it can be passed into or held in a guide 82 such as a hook located on the side of the tower 10 diametrically opposite the cart 10, said guide 82 being suspended from the platform 60 at the top of the tower via a rope 83. On the platform 60, the length of the rope 83 is adjusted by a reel 84 so that the guide 82 moves vertically with a speed adapted to that of the cart 30.

The cart 30 is provided with an actuator 81 connected to one or both ends of the strap 80, and is activatable remotely by the operator. In response to a command from the operator, the actuator 81 stretches the strap 80 to encircle the tower 10 and lock the cart 30 and the blade 25 in position.

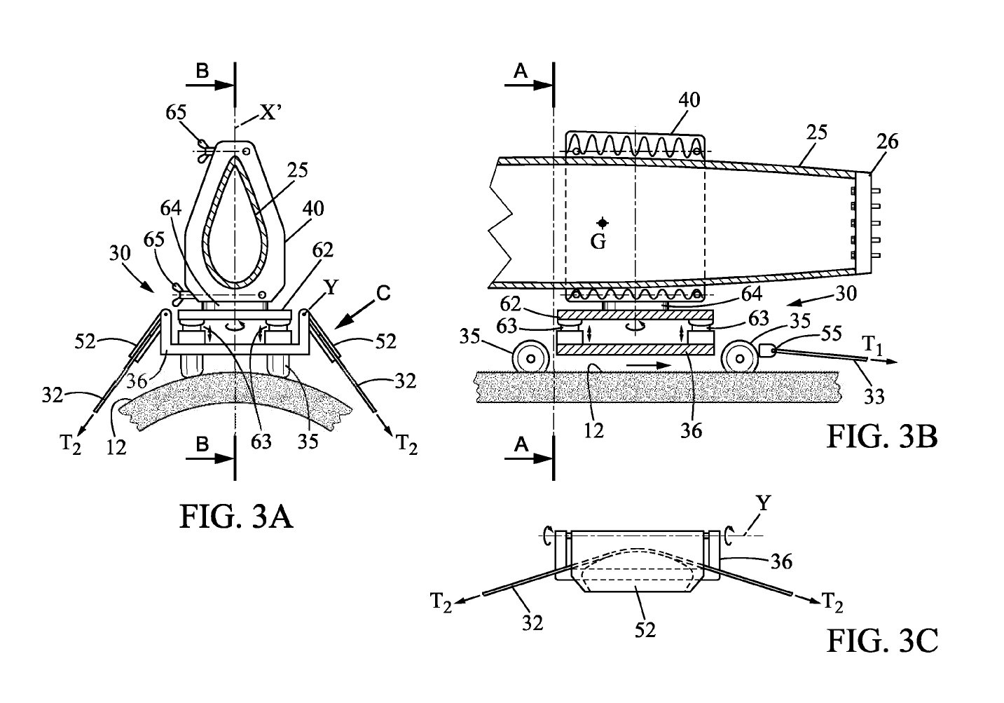

FIGS. 3A and 3B show in more detail a possible arrangement of the cart 30 shown in FIG. 1. The chassis 36 of the cart 30 is equipped with wheels 35 mounted on two axles in this example. At the front of the chassis 36 is the point of attachment 55 of the traction cable 33 (or one or more return pulleys if there is a cable 33 pulley block).

The blade support member 40 may be in the form of a clamp having two shells provided with an internal lining with a profile adapted to the outer profile of the blade 25 in the area where it is held. The profile of the interior lining of the support member 40 is oriented, relative to the longitudinal axis of the blade 25, so that it is opposite its location on the hub 21 of the generator, with a suitable angular position at the connection of the blade on the hub. The lining may be flexible to better ensure that the composite material of the blade 25 is not damaged. The two shells are gathered around the blade 25 when it is gripped by the clamp 40, and held against each other, with the blade therebetween, by means of threaded rods 65 or other suitable assembly means.

As shown in FIGS. 1, 2 and 3B, the blade 25 is held in the support member 40 in an region between its proximal end 26 and its centre of gravity G. Thus, the distal end 27 of the blade is naturally directed downward as the cart 30 progresses along the tower 10.

Preferably, the area where the blade 25 is held in the support member 40 is much closer to the centre of gravity G than to the proximal end 26. This limits the need to compensate for the angular momentum of the blade 25 around the axis X′ when the blade is lifted from the ground.

The cart 30 shown in FIGS. 3A-B comprises a plate 62 mounted on the chassis 36 via telescopic support members 63 which can be remotely controlled to adjust the orientation and the position of the plate 62 relative to the chassis 36. In the non-limiting example shown in FIGS. 3A-B, there are four telescopic support members 63 near the four corners of the chassis 36 which is generally rectangular. Each support member 63 comprises an actuator, for example a jack, associated with a power source (not shown) on board the cart and can be controlled by means of a remote control by an operator controlling the handling from the nacelle 15.

The cart 30 shown in FIGS. 3A-B further comprises a pivoting bearing 64 interposed between the plate 62 and the blade support member 40 to allow the pivoting of the blade holder about the aforementioned axis X′. The bearing 64 may optionally be motorized so that the operator can also adjust the angular position of the support member 40 and the blade 25 around the axis X′ when the proximal end 26 is close to its location on the hub 21.

FIGS. 3A and 3C show a way of mounting the angular return elements 52 for the guide cables 32 on the cart 30. In this example, each angular return element has the shape of a saddle 52 on which the guide cable 32 is deviated. The saddle 52 has a curved track on which the cable 32 is supported. This curved track is sandwiched between two plates that let the guide cable 32 pass through while maintaining its position on the track. These two plates form a unit which is articulated on the chassis 36 of the cart 30 about an axis Y parallel to the direction of movement of the cart 30 along the tower 10. This arrangement, provided symmetrically on both sides of the chassis 36, allows the guide cables 32 to perform their function regardless of the height of the cart 30 along the tower 10.

During the installation of a blade 25, the operator can adjust the position of the proximal end 26 of the blade once the cart 30 reaches the top of its path along the tower. The position of the proximal end 26 is adjusted relative to the location provided for the blade on the hub 21 of the rotor.

To this end, the operator, located at a control station arranged on the nacelle 15 and using an appropriate control interface, can take advantage of the following degrees of freedom:
rotation of the generator 20 around the axis Z with respect to the tower 10;
rotation of the hub 21 about the axis X;
vertical translation of the cart 30, upwards or downwards, by means of the winch/brake 57;
rotating the blade 25 on the cart 30 about the axis X′, for example by means of the motorized ring 64;
translation in the radial direction relative to the tower 10, for example by synchronized control of the telescopic support members 63;
rotation about a horizontal axis perpendicular to the radial plane P, for example by differential control of the telescopic support members 63 located at the front of the cart 30 and the telescopic support members 63 located at the rear of the cart 30;
rotation about the longitudinal axis of the blade, for example by differential control telescopic support members 63 located on the left side of the cart 30 and telescopic support members 63 located on the right side of the cart 30.

These adjustment operations can be performed while the blade 25 is firmly held relative to the tower 10 by the guide and traction cables 32, 33. In addition, as the blade 25 is oriented vertically, the tower 10 gives it some protection against the wind.

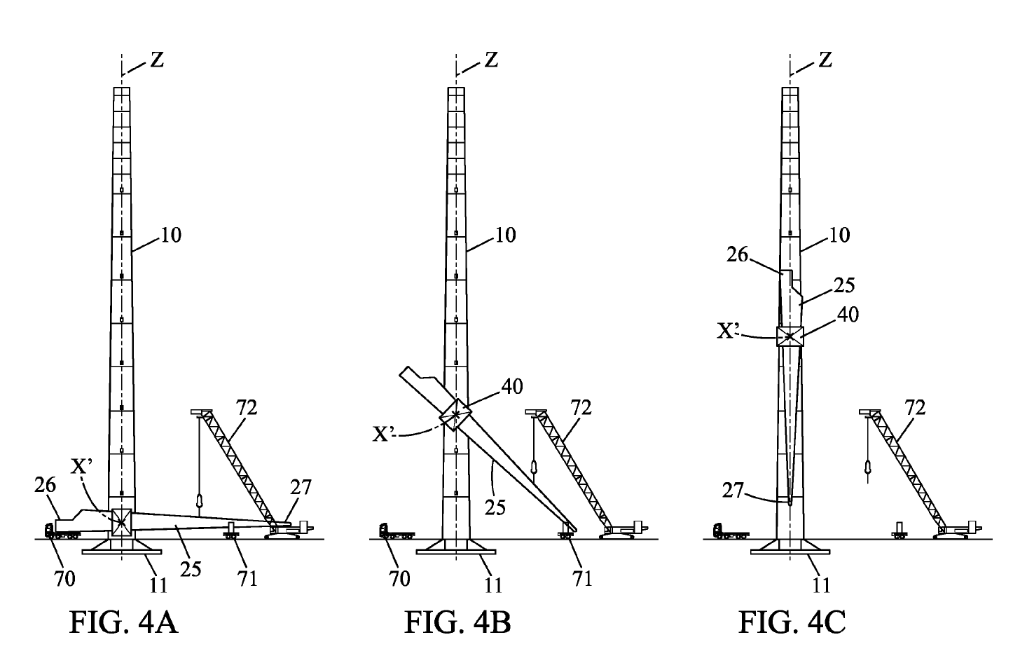

FIGS. 4A-C are an illustration of a procedure for loading the blade 25 to be mounted along the wind turbine tower 10. Initially (FIG. 4A), the blade 25 is brought into a horizontal position at the foot of the tower 10 using one or more vehicles 70, 71. At this moment, the cart 30 is in the low position, and the support member 40 is put in place on the blade 25 in the appropriate area between its centre of gravity G and its proximal end 26. Once the blade 25 is gripped in the support member 40, the winch 57 is actuated to initiate the ascent of the cart 30 (FIG. 4B). In this phase, a small crane 72 can be used to support the distal portion 27 of the blade. There is no need for a very powerful crane since the blade 25 is held by the support member 40 in an area close to its centre of gravity.

Once the cart 30 has reached a height where the blade 25 is oriented vertically (FIG. 4C), the activation of the winch 57 is maintained so that the cart 30 continues to ascend to the docking position of the blade on the rotor. At this point, the adjustment of the handling can be completed by the operator as indicated above.

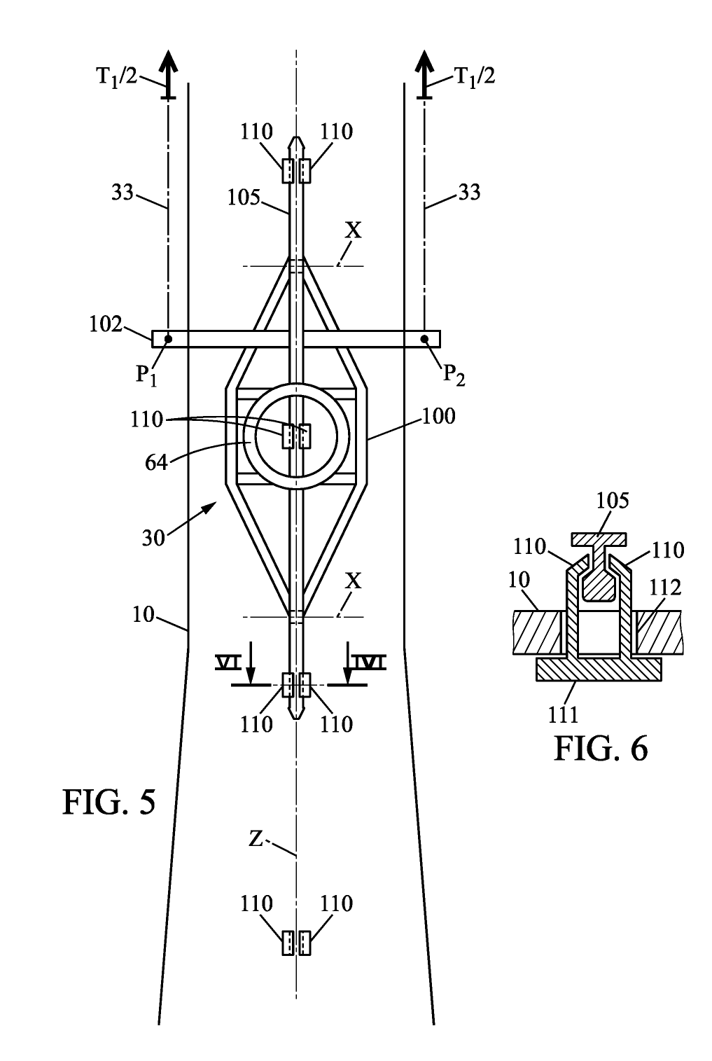

FIG. 5 illustrates an alternative embodiment, in which the chassis 100 of the cart 30 presents, towards the tower 10:
the wheels (not shown) facilitating sliding of the cart in the radial plane of movement P; and
a guide rail 105, which is arranged vertically when the cart is brought against the tower.

On the top of the cart 30, the chassis 100 carries the ring 64 for the rotation of the blade support member 40 about the axis X′ as previously described. In the example described, the chassis 100 also has a transverse beam 102 on which two traction cables 33 are hooked at positions P₁, P₂ symmetrical with respect to the plane P. These two traction cables 33 have an inclination as described previously in FIG. 1, so that the cart 30 is held against the tower 10 by a force having a horizontal component resulting from the traction T₁/₂ exerted on the cables 33. The cables 33 are for example each returned by a respective pulley 56 located at the top of the tower 10 and each connected to a respective winch 57 located at the base of the tower 10. Another possibility, similar to that described with reference to FIG. 2, is to place on the beam 102 two return pulleys (such as 58) at positions P1, P2 to perform reeving of a single traction cable 33.

The guide rail 105 is aligned in the radial plane of movement P passing through the axis Z of the tower 10. In a variant, it is possible to provide a plurality of parallel guide rails, preferably arranged symmetrically with respect to the plane P.

The (or each) guide rail 105 engages with shoes 110 which are arranged on the wall of the tower 10. The shoes 110 are distributed at different levels along the height of the tower 10. These levels can be spaced a little less than half the length of the rail 105 so that the rail always engages with shoes located at two or three consecutive levels so that the rail is properly aligned vertically.

If the tower 10 was constructed using a method such as that described in WO 2015/177413 A1, its wall consists of stacked annular segments each having one or more recesses or windows to the outside. As shown in FIG. 6, we can take advantage of windows 112 formed in the wall of the tower 10 to introduce parts 111 which incorporate or support the shoes 110 of the guide system. In the example shown, each piece 111 comprises a support plate which bears against the inner face of the wall of the tower 10 around the window 112, and two lugs forming a pair of shoes 110 which pass through the window 112 to pass through to the outside of the wall. The rail 105 engages between the two shoes 110 to guide the cart 30 during its vertical movement. As shown in FIG. 6, the shoes 110 have their end curved so that they help to maintain the rail 105 and the cart 30 against the wall of the tower 10 during the handling.

When the tower 10 has a non-constant cross section, for example a frustoconical base topped by a portion of cylindrical shape, one can provide the rail 105 with one or more joints about horizontal axes Y perpendicular to the plane P (FIG. 5), to facilitate the crossing of section transition areas along the tower.

In an alternative embodiment, the vertical rail 105 is not carried by the cart 30, but attached to the tower 10, for example using the aforementioned windows 112. The rail then runs along the majority of the height of the tower so as to cover the path of the cart on the facade. The shoes 110 engaging with this fixed rail are then carried by the underside of the cart 30, to ensure the vertical guidance thereof. This rail 105 can be fixed to the tower 10 temporarily for handling the blades 25.

The embodiments described above are a simple illustration of the present invention. Various modifications may be made without departing from the scope of the invention which is clear from the appended claims.

1. A method for handling a wind turbine blade between the ground and an electric generator rotor installed on a nacelle at the top of a tower, the method comprising:
holding the blade in a blade support member mounted on a cart placed against the tower; and
moving and guiding the cart along the tower, using at least one cable inclined so as to exert a force on the cart having a horizontal component in a direction towards the tower.

2. The method as claimed in claim 1, wherein the guiding of the cart along the tower is performed independently of the nacelle which is mounted at the top of the tower so as to be pivotable around a vertical axis.

3. The method as claimed claim 1, wherein a guide system is installed between the cart and the tower, the guide system comprising at least one vertical rail and shoes engaging with the rail to guide the cart as it moves along the tower.

4. The method as claimed in claim 3, wherein the shoes further engage with the rail so as to maintain the cart against the tower.

5. The method as claimed in claim 3, wherein the rail belongs to the cart and the shoes are mounted on the tower.

6. The method as claimed in claim 5, wherein the shoes are installed through windows provided in the wall of the tower during the construction of the tower.

7. The method as claimed in claim 3, wherein the rail is attached to the tower and the shoes are located in a lower portion of the cart.

8. The method as claimed in claim 1, wherein two guide cables are arranged symmetrically on either side of a vertical plane, each guide cable being connected to a point located at foot of the tower and at a point located in an upper part of the tower and being deviated on an angular return element provided on the cart.

9. The method as claimed in claim 8, wherein the connection points of the two guide cables are arranged so that the guide cables exert a force having a horizontal component in the direction towards the tower on the angular return elements of the cart.

10. The method as claimed in claim 8, wherein the connection points of the two guide cables in the upper part of the tower are arranged on the tower below the nacelle.

11. The method as claimed in claim 8, wherein the guide cables have adjustable tension.

12. The method as claimed in claim 1, wherein at least one traction cable is connected to the cart for driving the cart as it ascends along the tower, or for retaining the cart as it descends along the tower, the traction cable being inclined so that the traction that it exerts on the cart has a horizontal component in a direction towards the tower.

13. The method as claimed in claim 12, wherein the cart comprises at least one return pulley to perform reeving of the traction cable.

14. The method as claimed in claim 12, wherein the traction cable is deviated by at least one pulley located in an upper part of the tower and connected to a winch or a brake located at the base of the tower.

15. The method as claimed in claim 1, wherein the blade support member is pivotally mounted on the cart, about a substantially horizontal axis.

16. The method as claimed in claim 15, wherein the blade has a proximal end for connection to the electric generator rotor and a distal end opposite the proximal end, and the blade support member holds the blade in an area between the proximal end and the centre of gravity of the blade.

17. The method as claimed in claim 16, wherein the area where the blade support member holds the blade is closer to the centre of gravity (G) than to the proximal end.

18. The method as claimed in claim 1 comprising:
bringing the blade to the foot of the tower in a horizontal position;
gripping the blade in the blade support member mounted on the cart;
starting an upward movement of the cart by supporting a distal portion of the blade until the cart has reached a height where the blade extends vertically with its distal end downward; and
continuing to move up the cart until a proximal end of the blade reaches the electric generator rotor.

19. The method as claimed in claim 1, wherein the blade support member comprises a clamp having a lining adapted to an outer profile of the blade.

20. The method as claimed in claim 1, wherein the electric generator rotor is positioned to have a hub location facing a proximal end of the blade, and wherein the cart upon reaching the top of its path along the tower is controlled to adjust the position of the proximal end of the blade relative to the hub location.

21. The method as claimed in claim 20, wherein the cart is arranged to provide adjustment of the position of the proximal end of the blade in at least one degree of freedom among translation in a radial direction relative to the tower, rotation about a horizontal axis perpendicular to a radial plane with respect to the tower, and rotation about a longitudinal axis of the blade.

22. The method as claimed in claim 1, wherein a system for locking the cart relative to the tower is activatable by an operator.

23. The method as claimed in claim 22, wherein the locking system comprises a strap connected to the cart and forming a loop around the tower, the cart being equipped with an actuator for tensioning the strap in response to an operator input.
